(19) United States
(12) Patent Application Publication
(10) Pub. No.: US 2008/0194233 A1
(43) Pub. Date: Aug. 14, 2008

(54) Systems and methods for context-aware service subscription management

(75) Inventor: Pascal Henry, Enghien-les-Bains (FR)

Correspondence Address: STERNE, KESSLER, GOLDSTEIN & FOX P.L.L.C., 1100 NEW YORK AVENUE, N.W., WASHINGTON, DC, 20005, US

(73) Assignee: Bridgewater Systems Corp., Ottawa (CA)

(21) Appl. No.: 11/705,144

(22) Filed: Feb. 12, 2007

(51) Int. Cl. H04M 1/66

(52) U.S. Cl. 455/411; 455/406

(57) ABSTRACT

Systems and methods for context-aware service subscription management are provided. In an embodiment a context-aware service subscription management system includes a policy decision module that makes a decision whether the requested service will be provided based on policy rules, subscription profiles and the context of the request for the service. The use of context to make the policy decision allows for services offerings to be adjusted dynamically to the context of a particular user's service request. The subscription management system further includes a policy rules module, subscription profile interface and a context analysis module. The policy rules module provides policy rules. The context analysis module determines the context of a service request. Based on context information, the policy decision module in effect temporarily overrides a subscription profile based on the context of a service access by the user. Methods of use for the context-aware service subscription management systems are also provided.

### BACKGROUND OF THE INVENTION

1. Field of the Invention

The present invention relates to communications, and more particularly, to context-aware service subscription management.

2. Background of Invention

Access authorization and service subscription management systems enforce service authorization decisions within a communication network based on end-user subscription profile and service preference data. In some instances, tools like a marketing campaign management system may also be used to modify the default end-user subscriptions during a pre-defined period of time. Current systems are limited in that all of the decision criteria discussed above are static in nature, requiring that subscription profile and service preference databases be predefined and pre-populated. A service policy decision is a decision that determines whether a user should be permitted to access a service and the condition upon which service is provided. Because of the static nature of the decision making process, service policy decision enforcement cannot be correlated to the context of a transaction or session. As a result, service providers are limited in their flexibility to tailor and individualize service delivery conditions and experiences to users.

What are needed are cost effective systems and methods for context-aware service subscription management that dynamically adapt the conditions of service delivery and/or service experience based on the context of a user's service request.

### SUMMARY OF THE INVENTION

The present invention provides systems and methods for context-aware service subscription management. In an embodiment a context-aware service subscription management system includes a policy decision module that makes a decision whether the requested service will be provided and the conditions of its delivery. The decision is based on policy rules, subscription profiles and the context of the request for the service. The use of context to make the policy decision allows for service offerings to be adjusted dynamically to the context of a particular user's service request.

The subscription management system further includes a policy rules module, subscription profile interface and a context analysis module. The policy rules module provides policy rules, which set forth rules to determine the conditions upon which a service will be delivered. The context analysis module determines the context of a service request and provides that information to the policy decision module. The policy decision module uses the contextual information to in effect temporarily override a subscription profile based on the context of a service request by the user. Methods of use for the context-aware service subscription management systems are also provided.

Further embodiments, features, and advantages of the invention, as well as the structure and operation of the various embodiments of the invention are described in detail below with reference to accompanying drawings.

### BRIEF DESCRIPTION OF THE FIGURES

The present invention is described with reference to the accompanying drawings. In the drawings, like reference numbers indicate identical or functionally similar elements. The drawing in which an element first appears is indicated by the left-most digit in the corresponding reference number.

FIG. 1 provides a diagram of a communications network employing a context-aware service subscription management system, according to an embodiment of the present invention.

FIG. 2 provides a diagram of a context-aware service subscription management system, according to an embodiment of the present invention.

FIG. 3 provides a diagram of a context-aware service subscription management system with optional interfaces, according to an embodiment of the present invention.

FIG. 4 provides a flowchart of a method to deliver a service to a user within a communications network, according to an embodiment of the present invention.

FIG. 5 provides a flowchart of a method to deliver a service to a user within a communications network that includes consideration of marketing campaign and user profiles, according to an embodiment of the present invention.

FIG. 6 is a diagram of a computer system on which the methods and systems herein described can be implemented, according to an embodiment of the invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

As used herein, the term “subscription” refers to the commercial relationship between a subscriber and a service provider. The term “service preference” contains the service preferences chosen for a user. Each user configures his preferences for a particular subscribed service, but only within the limits defined by the subscription. The term “subscription profile” defines a set of data managed and stored by network domains and subsystems for the operation and execution of the services provided to a specific user associated with a subscriber.

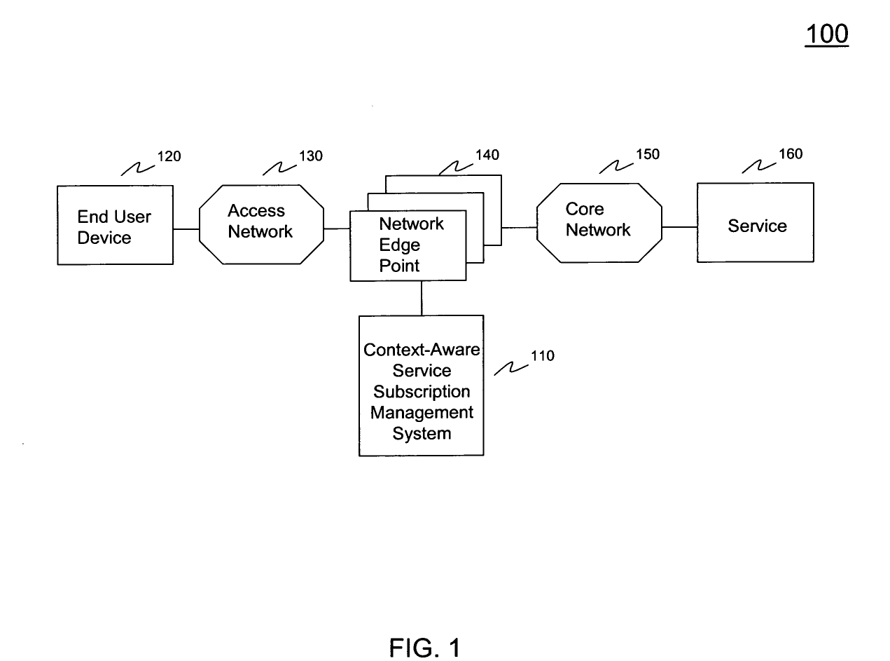

FIG. 1 provides a diagram of network 100 employing context-aware service subscription management system 110, according to an embodiment of the present invention. Network 100 includes context-aware service subscription management system 110, end user device 120, access network 130, network edge point 140, core network 150, and service 160. Network edge point 140 includes both edge device routers and service delivery platforms. Note that network 100 can support many end user devices and service providers.

End user device 120 is coupled to access network 130. End user device 120 can include, but is not limited to, a personal computer, a laptop computer, a cellular phone, a smart phone, an MP3 player, and a personal data assistant (“PDA”). In general end user device 120 includes electronic devices that enable an end user to access and use an electronic service over a communications network. End user device 120 is coupled to access network 130 in either a wireless, wireline or combined wireless/wireline connection.

Access network 130 includes one or more communications networks that facilitate the connection of end user device 120 to services offered by service and content providers, such as service 160. For example, access network 130 can include, but is not limited to the Internet, a private network, or a public switched telephone network.

Network edge point 140 provide access to service 160. Network edge point 140 can include routers, for example, that enforce policy decisions. In embodiments, when service delivery platforms are used, network edge point 140 can also refer to the portals. Network edge points 140 are coupled to context-aware service subscription management system 110. Network edge point 140 control access to and the conditions of delivery of service 160 provided to an end user device 120 based on the policy decisions that are transmitted from context-aware service subscription management system 110.

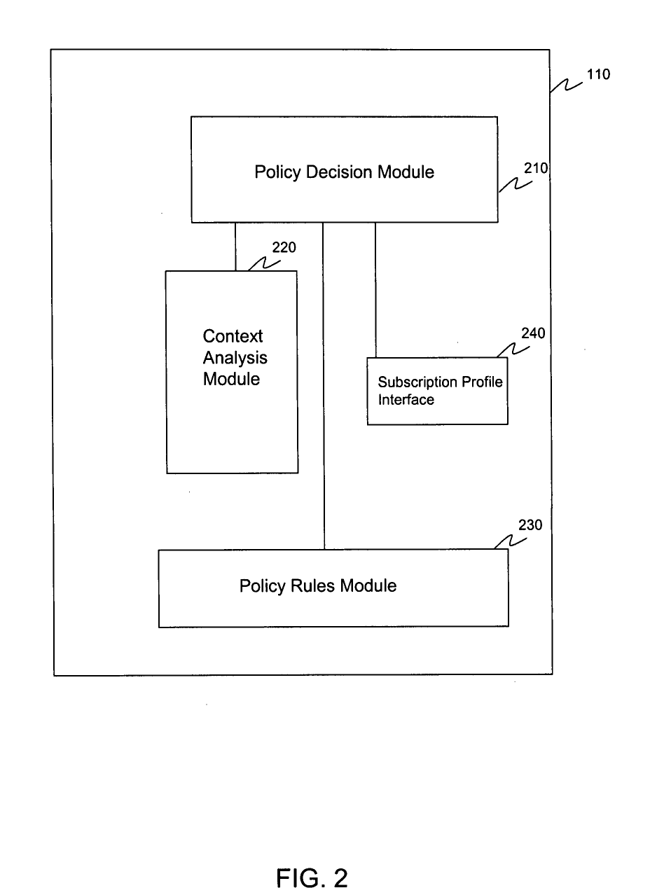

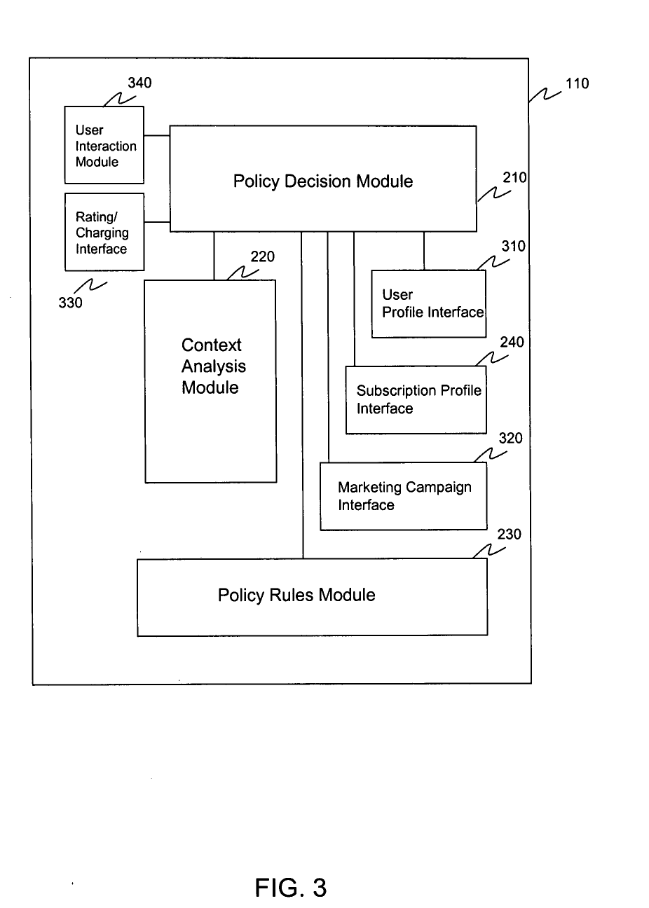

Context-aware service subscription management system 110 determines whether a user may access a requested service within a communications network. Context-aware service subscription management system 110 can also determine other service variables such as the quality of service to be provided and whether or not advertisements should be allowed. Context-aware service subscription management system 110's components and operation are discussed in detail with respect to FIGS. 2 and 3.

Core network 150 couples end user device 120 to service 160. Core network 150 can be the same network as access network 130, or can be different. Core network 150 can include, but is not limited to the Internet, a private network, or a public switched telephone network.

Service 160 includes communication and online services. Services can be provided by service providers that include, for example, web service providers that provide video, audio, gaming, advertisements or other online services. As discussed below in the example applications, service providers can include, but are not limited to, an auto dealership that provides an Internet website or a video sharing website.

FIG. 2 provides a diagram of context-aware service subscription management system 110, according to an embodiment of the present invention. Context-aware service subscription management system 110 includes policy decision module 210, context analysis module 220, policy rules module 230 and subscription profile interface 240.

Policy decision module 210 makes a decision whether a service requested by a user will be provided and the conditions of its delivery. The decision is based on policy rules, subscription profiles and the context of the request for the service.

Context analysis module 220 is coupled to policy decision module 210. Context analysis module 220 temporarily overrides a subscription profile based on the context of a service access by the user. Upon receipt of a service request, context analysis module 220 determines the context of the request. This contextual information is provided to policy decision module 210. Contextual information that can be obtained by context analysis module 220 includes, but is not limited to, location or presence information of the user, credit information regarding the user, recent user activity on the network, device type being used (e.g., is the user using an authorized device for the type of service), network load (e.g., peak hour), external factors (e.g., raining, snowing, traffic conditions, etc.) and whether the user opted in for an ad-subsidized mode during a session or transaction.

The use of contextual information can support services, such as, for example optionally allowing ad-subsidized access to content and services with dependency on real-time contextual information. Another application that can be supported, for example, includes one in which service providers propose to targeted non-premium users discretionary access to services that are not covered by their subscription, as well as reduced prices (e.g., electronic happy hours) at the time of low network load (e.g. for the uploading of multimedia content by an end user.)

Policy rules module 230 is coupled to policy decision module 210. Policy rules module 230 provides policy rules that determine the conditions upon which a service will be delivered. The policy rules are a set of rules that guide whether a user will be granted access to a service. The policy rules are established by a system administrator or can be set by individual service providers for their particular services. The policy rules also can be set by an authorized principal. A principal is an entity that has an identity, who is capable of providing consent and other data, and to which authenticated actions are done on its behalf. Examples of principals include an individual user, a group of individuals, a corporation, service enablers/applications, system entities and other legal entities.

Subscription profile interface 240 is coupled to policy decision module 210. Alternatively, a subscription profile system can exist within context-aware service subscription management system 110. As stated above a subscription profile is a set of data for the operation and execution of a service provided to the user. Subscription profile interface 240 allows policy decision module 210 to gather subscription profiles for users requesting service. The subscription profile interface can also provide access to information regarding the service preferences of a user.

FIG. 3 provides a diagram of a context-aware service subscription management system 110 with optional interfaces, according to an embodiment of the present invention. The optional interfaces include user profile interface 310, marketing campaign interface 320, and rating/charging system interface 330. Additionally, context-aware service subscription management system 110 includes user interaction module 340.

User profile interface 310 is coupled to policy decision module 210. Alternatively, a user profile system can exist within context-aware service subscription management system 110. A user profile system includes use profiles (e.g., the use characteristics for a particular subscriber). Policy decision module 210 uses user profile information in combination with contextual information from context analysis module 220 to make a policy decision.

Marketing campaign interface 320 is coupled to policy decision module 210. Alternatively, a marketing campaign system can exist within context-aware service subscription management system 110. A marketing campaign system provides adjustments to billing parameters during a marketing promotion over a predefined period of time. Policy decision module 210 uses marketing campaign information in combination with contextual information from context analysis module 220 to make a policy decision.

Rating/charging system interface 330 is coupled to policy decision module 210. Alternatively, a rating/charging system can exist within context-aware service subscription management system 110. In this case, policy decision module 210 provides contextual-based cost information to rating/charging system interface 330. For example, if an end user agrees to advertisements to be included within requested content, policy decision module 210 sends a message to rating/charging system interface 330 that indicates a reduced rating for the service should apply.

User interaction module 340 is also coupled to policy decision module 210. User interaction module 340 interacts with a user to gather further information that is used in combination with contextual information by policy decision module 210 to make a policy decision. For example, following a service request, user interaction module 340 may provide instructions to inquire whether the user would like to receive ad-subsidized content. In this case, future content can be provided, depending on the context of the service request, with ads to reduce service costs.

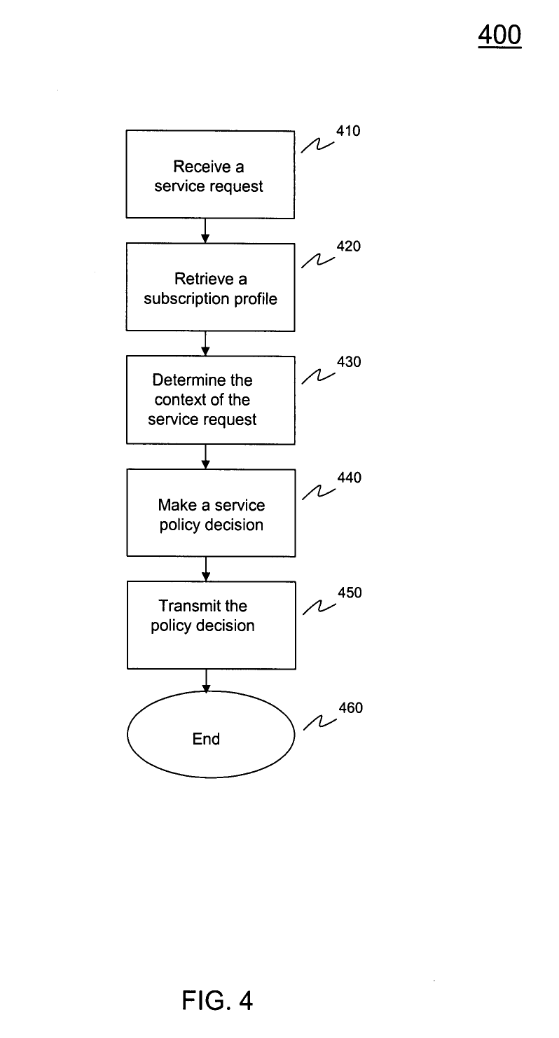

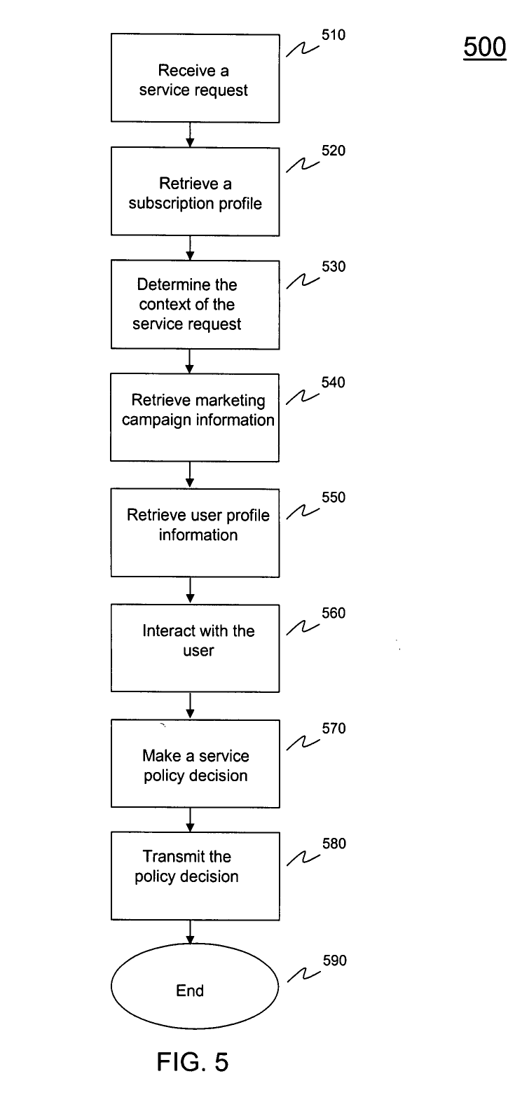

FIGS. 4 and 5 provide flowcharts of a method 400 and a method 500 to deliver a service to a user within a communications network that uses a context-aware service subscription management system, such as context-aware service subscription management system 110, according to an embodiment of the present invention.

Referring to FIG. 4, method 400 begins in step 410. In step 410 a service request is received. For example, context-aware service subscription management system 110 receives a service request from end user 120. The service request is processed by policy decision module 210.

In step 420 a subscription profile for the user is retrieved. The subscription profile is a set of data for the operation and execution of the request service to be provided to the user. For example, policy decision module 210 can retrieve subscription profile information through subscription profile interface 240.

In step 430 one or more contexts for the service request are determined. In one embodiment, context analysis module 220 determines the context for the service request. Context analysis module 220 can include a set of contexts to consider on each service request, or the contexts to be examined can be a function of time of day, day of week, network load, or other parameter. Example contexts that can be considered include, but are not limited to, location or presence information of the user, recent user activity on the network, device type being used (e.g., is the user using an authorized device for the type of service), network load (e.g., peak hour), has the user opted in for ad subsidized mode during a session or transaction.

In step 440 a service policy decision is made. The service policy decision determines whether access will be permitted, and can also include the conditions of service delivery. In an embodiment, the service policy decision is based on the subscription profile obtained from subscription profile interface 240, a policy rule or rules obtained from policy rules module 230 and the context of the service request that was determined by context analysis module 220.

In step 450 the service policy decision is transmitted. For example, policy decision module 210 transmits the policy decision to network edge point 140. Network edge point 140 enforce the policy decision to either grant or deny access to the service requested, and optionally to enforce the operating conditions that may be included in the service policy decision. In step 460 method 400 ends.

FIG. 5 provides a flowchart of method 500 that also delivers a service to a user within a communications network that uses a context-aware service subscription management system, such as context-aware service subscription management system 110, according to an embodiment of the present invention. The difference between methods 400 and 500 is that in method 500 additional inputs, such as user interaction results, user profiles and marketing campaign information are integrated into the service policy decision. The first three steps of method 500 are the same as those in method 400. Namely, in step 510 a service request is received. For example, context-aware service subscription management system 110 receives a service request from end user 120. The service request is processed by policy decision module 210.

In step 520 a subscription profile for the user is retrieved. For example, policy decision module 210 can retrieve subscription profile information through subscription profile interface 240. In step 530 one or more contexts for the service request are determined. In one embodiment, context analysis module 220 determines the context for the service request.

In step 540 marketing campaign information is received. For example, marketing campaign information can be received by policy decision module 210 through marketing campaign interface 320.

In step 550 user profile information is retrieved. For example, user profile information can be received by policy decision module 210 through user profile interface 310.

In step 560, optionally an interaction can occur with the user. Note that this step can occur at anytime prior to step 570. In an embodiment, user interaction module 340 transmits a message through policy decision module 210 to end user 120 to gather a user input. For example, the user may be asked whether they are willing to accept ad-sponsored content in order to reduce rates or increase bandwidth.

In step 570 a service policy decision is made. The service policy decision determines whether access will be permitted, and can also include the conditions of service delivery. In an embodiment, the service policy decision is based on the subscription profile obtained from subscription profile interface 240, a policy rule or rules obtained from policy rules module 230, the context of the service request that was determined by context analysis module 220 and one or more of user profile information, marketing campaign information and results from the user interactions.

In step 580 the service policy decision is transmitted. For example, policy decision module 210 transmits the policy decision to network edge point 140. Network edge point 140 enforce the policy decision to either grant or deny access to the service requested, and optionally to enforce the operating conditions that may be included in the service policy decision. In step 590 method 500 ends.

In both methods 400 and 500, an additional step that precedes the initial step occurs that provides configuration information to establish policy rules. In particular, policy rules are established and stored in policy rules module 230. These rules may be provided by a service provider, content provider, aggregator, advertiser or a system administrator. Additionally, in both methods policy decision information related to rating and billing can be transmitted to a rating/charging system through, for example, rating/charging system interface 330. Additionally, the policy decision can be transmitted to a content provider or service provider that supports the requested service.

The following example service implementations are provided as example uses of a context-aware service subscription management system, such as context-aware service subscription management system 110. The invention is not limited to these examples. Rather the examples are provided to illustrate particular applications of the invention to demonstrate how the invention can be applied to many other service offerings.

In the first example, a video sharing service “MyTube” is considering ways to offer incentives to its users to upload small video clips that users record on their mobile phones. Referring to FIG. 1, the service provider providing service 160 is MyTube and end user device 120 is a mobile phone. Under MyTube's standard data service subscription with it network provider, users pay per Kb of traffic, for both downlink and uplink traffic.

To address this issue, the network provider and MyTube agree on terms that grant MyTube with a bucket of non-chargeable minutes of uplink data traffic for its end users, provided that a certain volume of chargeable downlink traffic is generated. Also, per the terms, the non-chargeable minutes can only be used during periods of low network load. The service provider notifies MyTube on a regular time interval when the low network load periods occur, so that MyTube can notify its end users.

Based on these terms, MyTube offers a discounted uplink data service that leverages a context-aware service subscription management system, such as context-aware service subscription management system 110, provided by the network provider. Specifically, when a user has satisfied the conditions of download volumes, a WAP push is sent that notifies the user that he will be able to benefit from a “happy hour” period (e.g., 5 minutes, 15 minutes, etc.) for uploading his videos. For example, user interaction module 340 can transmit a message instructing a WAP push to be sent. The WAP push will also indicate the start/end time of the happy hour. The WAP push brings the user to a web page, where he can activate by clicking on a button/link his “happy hour” offer and start his period of free uploads.

Once the user clicks on the happy hour button this will start the happy hour period. During the happy hour period, when a service request is received from the user, policy decision module 210 will receive an indication from context analysis module 220 noting that the context for the request is within a happy hour. In effect, a quasi “contextual service subscription” is created that will dynamically override the existing user standard subscription.

Thus, policy decision module 210 will apply the context of the service request in accordance with the terms of the happy hour as would be set forth in policy rules module 230 to determine a policy decision. In turn, policy decision module 210 would either suspend billing for the session, or provide a billing indication to rating/charging system interface 330 that the session/upload should be for free. Upon the end of the happy hour period, the happy hour context would be eliminated and the existing user standard subscription would then apply.

In the second example, online services are subsidized by advertising. Car manufacturer, referred to as TopCars. TopCars would like to leverage the new possibilities offered by profile-targeted advertising on mobile phones. Based on a profiling information collection exercise, upon an end user opt-in, a network provider is able to offer to advertisers, like TopCars, access to end users whose profile matches against selected keywords, such as, for example “car.”

In one scenario, TopCars would like to be able to offer the following to a shortlist of customers that they have reason to believe may be a few weeks away from a car-buying decision. They would like to offer two hours of free video during the day if the user accepts to sign-up to “video subsidized advertising” when the user connects to his phone in the morning. The user will then get a 30-60 second advertising video clip from TopCars at the beginning of videos he will access during the day. In exchange, the first two hours of video watched during the day will be delivered free of charge to the user.

With the use of context-aware service subscription management system 110, additional context-aware-based features can be added to augment the service offering. For example, if the user is within a certain number of miles of a TopCar dealership, the user can be entitled to a higher bandwidth of service. For example, TopCar can create a policy rule that states that if a user is within X miles of a TopCar location, then they should receive a higher bandwidth service. This rule can be stored in policy rules module 230. Thus, when the user passes within X miles of a TopCar location, context analysis module 220 determines the context to be that the user is close to a TopCar location. This context is provided to policy decision module 210, which then makes a policy decision to provide the higher bandwidth service. In effect, the quasi contextual service subscription will override the user's standard subscription to provide the higher bandwidth service in a dynamic way based on location and the fact that the user had opted into the “video subsidized by advertising” offering.

### Computer System Implementation

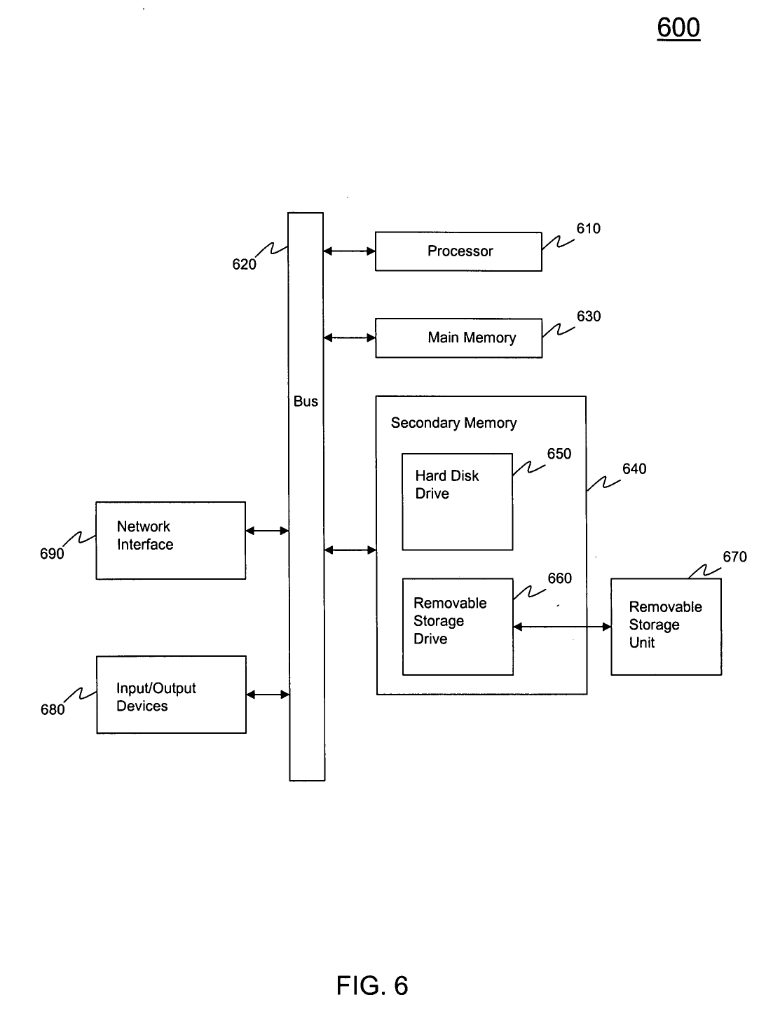

In an embodiment of the present invention, the methods and systems of the present invention described herein are implemented using well known computers, such as a computer 600 shown in FIG. 6. The computer 600 can be any commercially available and well known computer or server capable of performing the functions described herein, such as computers available from Gateway, Apple, Sun, HP, Dell, Cray, etc.

Computer 600 includes one or more processors (also called central processing units, or CPUs), such as processor 610. Processor 600 is connected to communication bus 620. Computer 600 also includes a main or primary memory 630, preferably random access memory (RAM). Primary memory 630 has stored therein control logic (computer software), and data.

Computer 600 may also include one or more secondary storage devices 640. Secondary storage devices 640 include, for example, hard disk drive 650 and/or removable storage device or drive 660. Removable storage drive 660 represents a floppy disk drive, a magnetic tape drive, a compact disk drive, an optical storage device, tape backup, etc.

Removable storage drive 660 interacts with removable storage unit 670. As will be appreciated, removable storage unit 660 includes a computer usable or readable storage medium having stored therein computer software (control logic) and/or data. Removable storage drive 660 reads from and/or writes to the removable storage unit 670 in a well known manner.

Removable storage unit 670, also called a program storage device or a computer program product, represents a floppy disk, magnetic tape, compact disk, optical storage disk, or any other computer data storage device. Program storage devices or computer program products also include any device in which computer programs can be stored, such as hard drives, ROM or memory cards, etc.

In an embodiment, the present invention is directed to computer program products or program storage devices having software that enables computer 600, or multiple computer 600s to perform any combination of the functions described herein

Computer programs (also called computer control logic) are stored in main memory 630 and/or the secondary storage devices 640. Such computer programs, when executed, direct computer 600 to perform the functions of the present invention as discussed herein. In particular, the computer programs, when executed, enable processor 610 to perform the functions of the present invention. Accordingly, such computer programs represent controllers of the computer 600.

Computer 600 also includes input/output/display devices 680, such as monitors, keyboards, pointing devices, etc.

Computer 600 further includes a communication or network interface 690. Network interface 690 enables computer 600 to communicate with remote devices. For example, network interface 690 allows computer 600 to communicate over communication networks, such as LANs, WANs, the Internet, etc. Network interface 690 may interface with remote sites or networks via wired or wireless connections. Computer 600 receives data and/or computer programs via network interface 690. The electrical/magnetic signals having contained therein data and/or computer programs received or transmitted by the computer 600 via interface 690 also represent computer program product(s).

The invention can work with software, hardware, and operating system implementations other than those described herein. Any software, hardware, and operating system implementations suitable for performing the functions described herein can be used.

### CONCLUSION

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

The present invention has been described above with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention. Thus, the breadth and scope of the present invention should not be limited by any of the above-described exemplary embodiments, but should be defined only in accordance with the following claims and their equivalents.

What is claimed is:

1. A context-aware service subscription management system that determines whether a user may access a requested service within a communications network, comprising:
a policy decision module that makes a decision whether the requested service will be provided, wherein the decision is based on policy rules, subscription profiles and a context of the request for the service;
a policy rules module coupled to the policy decision module that provides policy rules that determine a condition upon which a service will be delivered, wherein policy rules are a set of rules that guide whether a user will be granted access to a service;
a subscription profile system or interface coupled to the policy decision module, wherein a subscription profile is a set of data for the operation and execution of a service provided to the user; and
a context analysis module coupled to the policy decision module that determines the context of the service request and temporarily overrides a subscription profile based on the context of a service access by the user.

2. The context-aware service subscription management system of claim 1, further comprising a rating/charging system or rating/charging system interface coupled to the policy decision module, wherein the policy decision module provides contextual based cost information to the rating/charging system or rating/charging system interface.

3. The context-aware service subscription management system of claim 1, further comprising a user profile system or user profile interface coupled to the policy decision module, wherein the policy decision module uses user profile information in combination with contextual information from the context analysis module to make a policy decision.

4. The context-aware service subscription management system of claim 1, further comprising a marketing campaign management system or a marketing campaign interface coupled to the policy decision module, wherein the policy decision module uses marketing campaign information in combination with contextual information from the context analysis module to make a policy decision.

5. The context-aware service subscription management system of claim 1, further comprising a user interaction module coupled to the policy decision module, wherein the user interaction module interacts with a user to gather further information that is used in combination with contextual information by the policy decision module to make a policy decision.

6. The context-aware service subscription management system of claim 1, wherein conditions of service delivery made by the policy decision module are based on the context of the service request.

7. The context-aware service subscription management system of claim 6, wherein conditions include service quality.

8. The context-aware service subscription management system of claim 6, wherein conditions include whether advertisements are inserted into the requested service.

9. The context-aware service subscription management system of claim 6, wherein conditions include the cost of the requested service.

10. The context-aware service subscription management system of claim 1, wherein the communications network is a wireline network, a wireless network or a network that includes both wireline and wireless network elements.

11. The context-aware service subscription management system of claim 1, wherein the context of the service request includes one or more of a location of the user, a presence of the user, recent activity of the user on the network, a type of device used by the user, a network load and whether the user has opted to receive advertisements for a session.

12. A method for delivering a service to a user within a communications network accessed over a communications link, comprising:
(a) receiving a service request for a user;
(b) retrieving a subscription profile for the user, wherein the subscription profile is a set of data for the operation and execution of a service provided to the user;
(c) determining the context of the service request;
(d) making a service policy decision to determine the conditions of service delivery based on the subscription profile, policy rules, and the context of the service request, wherein in reaching a policy decision the subscription profile is temporarily overridden based on the policy rules and the context of the service request; and
(e) transmitting the policy decision to one or more network edge points within the communications network for enforcement of the policy decision.

13. The method of claim 12, further comprising prior to step (a), receiving configuration information to establish policy rules for the service.

14. The method of claim 13, wherein the configuration information is received from a service provider, content provider, aggregator or advertiser.

15. The method of claim 12, further comprising retrieving marketing campaign related information, wherein the marketing campaign related information is factored into the policy decision.

16. The method of claim 12, further comprising retrieving user profile information, wherein the user profile information is factored into the policy decision.

17. The method of claim 12, further comprising transmitting the policy decision to a content provider or service provider that supports the requested service.

18. The method of claim 12, further comprising transmitting the policy decision to a rating/charging system.

19. The method of claim 12, wherein the communications network is a wireline network, a wireless network or a network that includes both wireline and wireless network elements.

20. The method of claim 12, wherein the context of the service request includes one or more of a location of the user, a presence of the user, recent activity of the user on the network, a type of device used by the user, a network load and whether the user has opted to receive advertisements for a session.
